(19) United States
(12) Patent Application Publication
(10) Pub. No.: US 2018/0365198 A1
(43) Pub. Date: Dec. 20, 2018

(54) METHOD AND APPARATUS FOR PROVIDING WEB BROWSING INTERFACE

(71) Applicant: NAVER CORPORATION, Seongnam-si (KR)

(72) Inventors: Hyo Kim, Seongnam-si (KR); Ji Ho Choi, Seongnam-si (JP); Yun Seok Lee, Seongnam-si (KR); Hyo Jung Kim, Seongnam-si (KR)

(21) Appl. No.: 15/850,889

(22) Filed: Dec. 21, 2017

(30) Foreign Application Priority Data
Jun. 20, 2017 (KR) 10-2017-0078047

(51) Int. Cl. G06F 17/21; G06F 17/22; G06F 17/30

(52) U.S. Cl. CPC G06F 17/212; G06F 17/30896; G06F 17/2288

(57) ABSTRACT

Provided is a method of providing a web browsing interface, the method including: splitting a tab into at least two spaces based on a space mode of the tab displayed on a web browser; displaying web pages respectively on the at least two spaces; performing an adjustment determining operation by determining at least one adjustment target web page from among the web pages respectively displayed on the at least two spaces and determining whether to adjust a scale of the at least one adjustment target web page or load another version of the at least one adjustment target web page; performing a web page adjusting operation by adjusting the scale of the at least one adjustment target web page or loading the other version of the at least one adjustment target web page based on a result of performing the adjustment determining operation.

### CROSS-REFERENCE TO RELATED APPLICATION

This application claims priority under 35 U.S.C. § 119 to Korean Patent Application No. 10-2017-0078047 filed on Jun. 20, 2017, in the Korean Intellectual Property Office, the entire contents of which are incorporated herein by reference.

### BACKGROUND OF THE INVENTION

### Field of the Invention

One or more embodiments relate to methods and apparatuses for providing a web browsing interface, and more particularly, to a method and apparatus for providing a web browsing interface, which determines an adjustment target web page from among web pages displayed in spaces on a web browser, and adjusts a scale of the adjustment target web page or loads another version of the adjustment target web page.

### Description of the Related Art

This section provides background information related to the present disclosure which is not necessarily prior art.

A web browser is an application program for searching for and using information in the Internet. The web browser is also referred to as a browser or an Internet browser. Users are able to do various activities, such as watch a video, exchange emails, and upload or download various types of data, through the web browser. General functions of the web browser include opening a web page, providing a recently visited uniform resource locator (URL) or a bookmark, and storing a web page.

### BRIEF SUMMARY OF THE INVENTION

This section provides a general summary of the inventive concept, and is not a comprehensive disclosure of its full scope or all features of the inventive concept.

One or more embodiments include adjusting a scale or changing a version of at least one web page in a web browsing interface capable of displaying a web page in each of the spaces on a web browser.

One or more embodiments also include providing a tool bar region corresponding to each of the spaces created on a web browser.

Additional aspects will be set forth in part in the description which follows and, in part, will be apparent from the description, or may be learned by practice of the presented embodiments.

According to one or more embodiments, a method of providing a web browsing interface includes: splitting a tab into at least two spaces based on a space mode of the tab displayed on a web browser; displaying web pages respectively on the at least two spaces; performing an adjustment determining operation by determining at least one adjustment target web page from among the web pages respectively displayed on the at least two spaces and determining whether to adjust a scale of the at least one adjustment target web page or load another version of the at least one adjustment target web page; performing a web page adjusting operation by adjusting the scale of the at least one adjustment target web page or loading the other version of the at least one adjustment target web page based on a result of performing the adjustment determining operation.

The method may further include providing tool bar regions respectively corresponding to the at least two spaces based on the space mode.

Each of the tool bar regions respectively corresponding to the at least two spaces may include an element indicating a state of a web page displayed in a corresponding space or an element generating an instruction of controlling the web page.

In the providing of the tool bar regions, the tool bar regions respectively corresponding the at least two spaces may be provided when the space mode is a separation mode, wherein the separation mode may be a mode of, when an input of selecting a link in a web page displayed in a particular space from among the at least two spaces is received, loading a web page corresponding to the link in the particular space.

In the performing of the adjustment determining operation, the determining of whether to load the other version may include determining whether a version of the at least one adjustment target web page is a first version or a second version, and when it is determined that the version is the first version, loading the second version of the at least one adjustment target web page.

The first version of the at least one adjustment target web page may have a larger total data amount of a web page than the second version of the at least one adjustment target web page.

One of the at least one adjustment target web page may be displayed in a main space of the web browser, and when an input of selecting a link in a web page displayed in the main space is received, the web browser may load a web page corresponding to the link in another space instead of the main space.

One of the at least one adjustment target web page may be displayed in a left space of the web browser.

In the performing of the adjustment determining operation, all of the web pages displayed respectively in the at least two spaces may be determined as adjustment target web pages, or a web page selected based on a user input may be determined as an adjustment target web page.

In the performing of the web page adjusting operation, the scale of the at least one adjustment target web page may be adjusted such that the lengths or the widths of contents of the web pages respectively displayed in the at least two spaces are equal to or smaller than the lengths or the widths of the at least two spaces.

According to one or more embodiments, an apparatus for providing a web browsing interface includes: a space splitter configured to split a tab into at least two spaces based on a space mode of the tab displayed on a web browser, and display web pages respectively on the at least two spaces; an adjustment determiner configured to determine at least one adjustment target web page from among the web pages respectively displayed on the at least two spaces and determine whether to adjust a scale of the at least one adjustment target web page or load another version of the at least one adjustment target web page; and a web page adjuster configured to adjust the scale of the at least one adjustment target web page or load the other version of the at least one adjustment target web page based on a result of the determining by the adjustment determiner.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 illustrates an example of a network environment according to an embodiment;

FIG. 2 is a block diagram of internal configurations of a user terminal and a server, according to an embodiment;

FIG. 3 is a block diagram of an internal configuration of a processor, according to an embodiment;

FIG. 4 is a flowchart of a method of providing a web browsing interface, according to an embodiment;

FIG. 5 illustrates an example of a web browser according to an embodiment;

FIGS. 6A, 6A and 6C illustrate examples of tabs according to space modes, according to an embodiment; and

FIGS. 7, 8, 9 and 10 illustrate examples of web browsers according to embodiments.

It should be noted that these figures are intended to illustrate the general characteristics of methods and/or structures utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by the example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those of ordinary skill in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, a central processing unit (CPU), a controller, an arithmetic logic unit (ALU), a digital signal processor, a microcomputer, a field programmable gate array (FPGA), a system-on-chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, a CPU, a controller, an ALU, a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording media, including tangible or non-transitory computer-readable storage media discussed herein,

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such a separate computer readable storage medium may include a universal serial bus (USB) flash drive, a memory stick, a Blu-ray/DVD/CD-ROM drive, a memory card, and/or other similar computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other similar medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one of ordinary skill in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different to that of the methods described, and/or components such as the described system, architecture, devices, circuit, and the like, may be connected or combined to be different from the above-described methods, or results may be appropriately achieved by other components or equivalents.

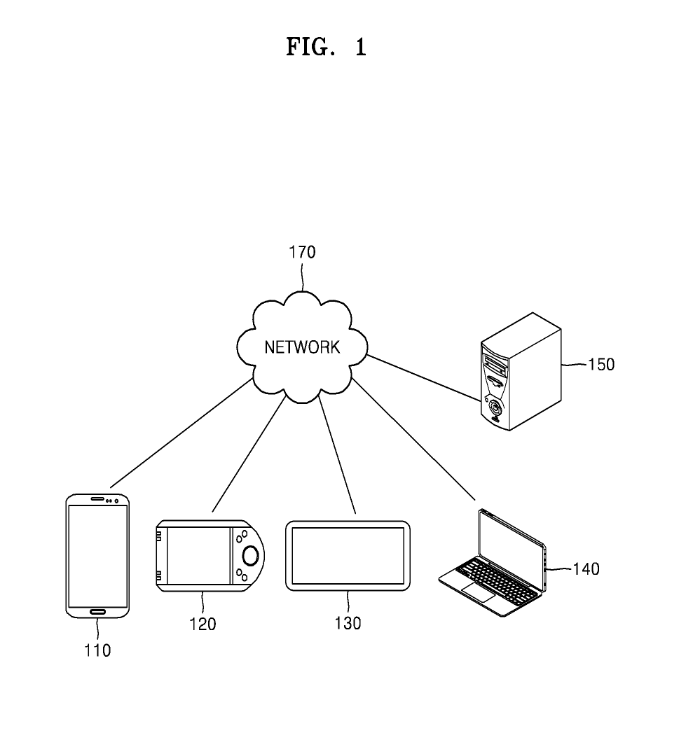

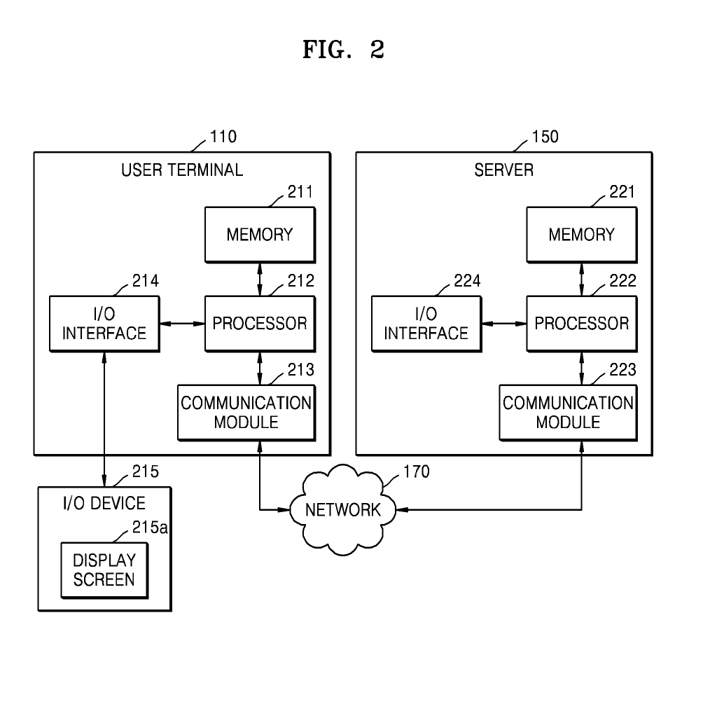

FIG. 1 illustrates an example of a network environment according to an embodiment.

The network environment of FIG. 1 includes a plurality of user terminals 110, 120, 130, 140, a server 150, and a network 170. However, the network environment of FIG. 1 is only an example, and the number of user terminals and the number of servers are not limited to those of FIG. 1.

The plurality of user terminals 110 through 140 may each be a fixed terminal or mobile terminal realized as a computer device. Examples of the user terminals 110 through 140 include a smart phone, a mobile phone, a navigation device, a computer, a laptop computer, a digital broadcasting terminal, a personal digital assistant (PDA), a portable multimedia player (PMP), and a tablet personal computer (PC). For example, the user terminal 110 may communicate with the other user terminals 120 through 140 and/or the server 150 through the network 170 by using a wireless or wired communication method.

A communication method is not limited, and may include not only a communication method using a communication network, such as a mobile communication network, a wired Internet, a wireless Internet, or a broadcasting network, which may be included in the network 170, but also a short-range wireless communication method between devices. For example, the network 170 may include at least one arbitrary network from among a personal area network (PAN), a local area network (LAN), a campus area network (CAN), a metropolitan area network (MAN), a wide area network (WAN), a broadband network (BBN), and the Internet. Also, the network 170 may include at least one of network topologies, such as a bus network, a star network, a ring network, a mesh network, a star-bus network, and a tree or hierarchical network, but is not limited thereto.

The server 150 may communicate with the plurality of user terminals 110 through 140 through the network 170 to be embodied as a computer device or a plurality of computer devices providing an instruction, a code, a file, content, or a service.

For example, the server 150 may provide a file for installing an application to the user terminal 110 connected through the network 170. In this case, the user terminal 110 may install the application by using the file provided from the server 150. Also, the user terminal 110 may receive a service or content provided by the server 150 by accessing the server 150 according to control of an operating system (OS) or at least one program (for example, a browser or an installed application) included in the user terminal 110. For example, when the user terminal 110 transmits a service request message to the server 150 through the network 170 according to control of an application, the server 150 may transmit a code corresponding to the service request message to the user terminal 110, and the user terminal 110 may form and display a screen based on the code according to control by the application so as to provide content to a user. As another example, the server 150 may set a communication session for data exchange, and route data between the plurality of user terminals 110 through 140 through the set communication session.

FIG. 2 is a block diagram of internal configurations of a user terminal and a server, according to an embodiment.

In FIG. 2, the user terminal 110 is described as an example of the user terminal and the server 150 is described as an example of the server. The other user terminals 120 through 140 may also have the same or similar internal configurations.

The user terminal 110 and the server 150 respectively include memories 211 and 221, processors 212 and 222, communication modules 213 and 223, and input/output (I/O) interfaces 214 and 224, The memories 211 and 221 are non-transitory computer-readable recording media, and may include a permanent mass-storage device, such as a random access memory (RAM), read-only memory (ROM), or a disk drive. Also, the memories 211 and 221 may store an operating system (OS) and at least one program code (for example, a code for a browser or an application as described above, which is installed in and driven by the user terminal 110). Such software components may be loaded from a computer-readable recording medium separate from the memories 211 and 221 by using a drive mechanism. Such a computer-readable recording medium may include a floppy drive, a disk, a tape, a DVD/CD-ROM drive, or a memory card. According to another embodiment, the software components may be loaded to the memories 211 and 221 through the communication modules 213 and 223 instead of from a computer-readable recording medium. For example, at least one program may be loaded to the memories 211 and 221 based on a program (for example, an application) installed by using files provided through the network 170 from a developer or a file distribution system (for example, the server 150) that distributes an installation file of the application.

The processors 212 and 222 may be configured to process an instruction of a computer program by performing basic arithmetic, logic, and I/O operations. The instruction may be provided to the processor 212 and 222 by the memories 211 and 221 or the communication modules 213 and 223. For example, the processors 212 and 222 may be configured to execute an instruction received according to a program code stored in recording media, such as the memories 211 and 221.

The communication modules 213 and 223 may respectively provide a function for the user terminal 110 and the server 150 to communicate with each other through the network 170, and may provide a function for communicating with another user terminal (for example, the user terminal 120) or another server. For example, a request generated by the processor 212 of the user terminal 110 according to a program code stored in a recording device, such as the memory 211, may be transmitted to the server 150 through the network 170 according to control of the communication module 213. The communication module 213 of the user terminal 110 may also receive a control signal, an instruction, content, or a file provided according to control by the processor 222 of the server 150, through the communication module 223 and the network 170. For example, a control signal or an instruction of the server 150 received through the communication module 213 may be transmitted to the processor 212 or the memory 211, and content or a file may be stored in a storage medium that may be further included in the user terminal 110.

The I/O interface 214 may be a unit for interfacing with an I/O device 215. For example, the I/O device 215 may include an input device that may be a keyboard or a mouse, and an output device that may be a display screen 215a for displaying a communication session of an application. As another example, the I/O interface 214 may be a unit for interfacing with a device in which input and output functions are integrated, such as a touch screen. For example, while the processor 212 of the user terminal 110 processes an instruction of a computer program loaded to the memory 211, a service screen or content configured by using data provided by the server 150 or the user terminal 210 may be displayed through the I/O interface 214. Also, according to another embodiment, the user terminal 110 and the server 150 may include more components than those shown in FIG. 2. Here, not all well-known components are necessarily clearly or wholly illustrated. For example, the user terminal 110 may include at least a part of the I/O device 215, or may further include another component, such as a transceiver, a global positioning system (GPS) module, a camera, one of various sensors, or a database.

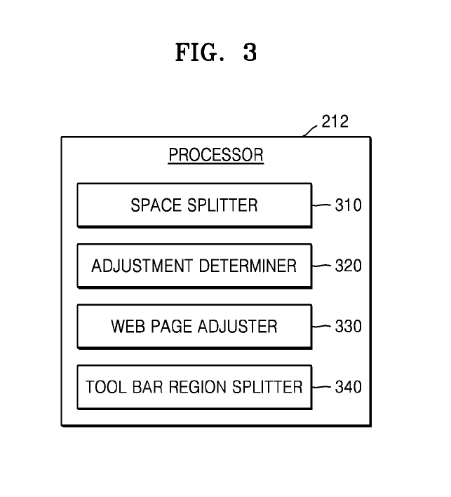

FIG. 3 is a block diagram of the internal configuration of the processor 212 of the user terminal 110, according to an embodiment.

The processor 212 is configured to execute a web browser that receives and outputs a web page online. The web browser according to an embodiment may be installed on the processor 212 by being provided from an external device, for example, downloaded from the server 150 or received from another device, or may be installed by being embedded in the processor 212. The components or units for performing the functions of the web browser in the processor 212, according to an embodiment, may include a space splitter 310, an adjustment determiner 320, a web page adjuster 330, and a tool bar region splitter 340 as shown in FIG. 3. According to an embodiment, the components of the processor 212 may be selectively included in or excluded from the processor 212. Also, according to an embodiment, the components of the processor 212 may be divided or integrated to represent a function of the processor 212.

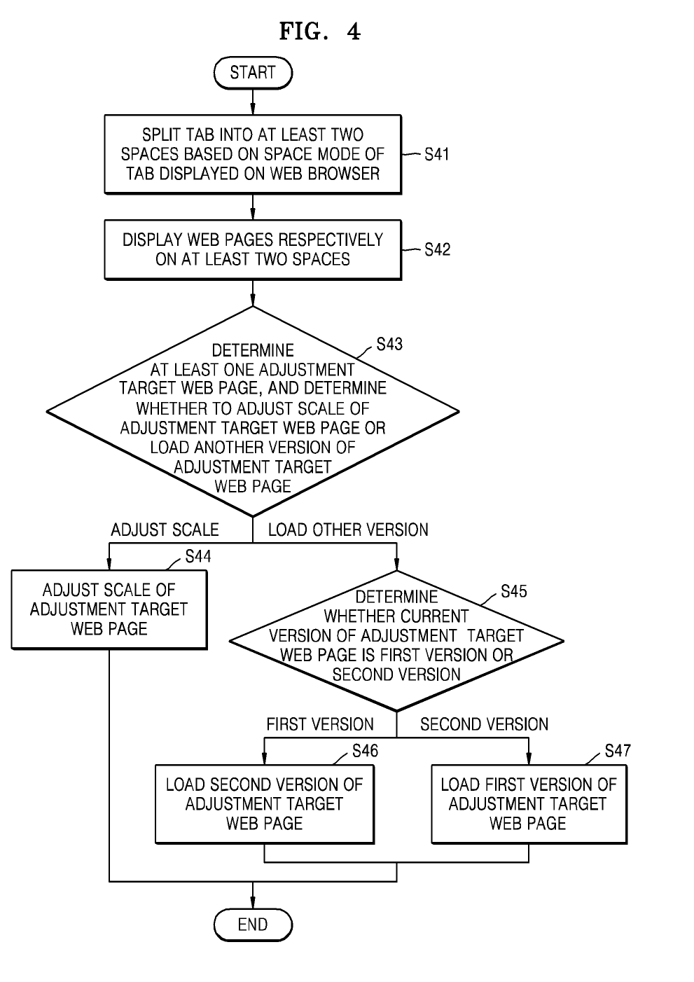

The processor 212 and the components of the processor 212 may control the user terminal 110 to perform the operations (operations S41 to S47) of a method of providing a web browsing interface of FIG. 4. For example, the processor 212 and the components of the processor 212 may be embodied to execute an instruction according to at least one program code and a code of an OS included in the memory 211.

Here, the components of the processor 212 may be representations of different functions of the processor 212, which are performed by the processor 212, according to instructions provided by program codes stored in the user terminal 110 (for example, instructions provided by a web browser driven by the user terminal 110).

FIG. 4 is a flowchart of a method of providing a web browsing interface, according to an embodiment.

First, in operations S41 and 342, the space splitter 310 splits a tab on a web browser into at least two spaces on the web browser, and displays web pages respectively on the at least two spaces, based on a space mode of the tab. The tab may mean a tab window. The tab may include a content display region displaying the web pages.

According to an embodiment, at least one tab included in a web browser may each load and display one or more web pages. The one or more web pages loaded and displayed by each tab may be displayed in a content display region of the web browser. Also, the tab may have one or more spaces, wherein the space denotes an area on the content display region where a web page may be loaded and displayed. One web page may be loaded and displayed in one space.

According to an embodiment, the space mode of the tab may be a general mode or a split mode, and the split mode may be classified further into a connection mode and a separation mode. When the space mode of the tab is the general mode, the tab may have one space and only one page may be loaded and displayed in the one space. When the space mode of the tab is the split mode, the space splitter 310 may split the tab into at least two spaces, and load and display different web pages in the at least two spaces.

For example, the space mode may be set based on a user input or a pre-set value of the web browser. For example, the user may change the space mode from the general mode to the split mode by selecting a ‘split’ mode button from a tool bar of the web browser. Alternatively, the user may change the space mode from the general mode to the split mode by selecting ‘open link in new space’ from a menu displayed when a particular link displayed on the web browser is selected via a right-click of a mouse, and load a web page corresponding to the particular link in a new space. Also, the space mode may be switched between the connection mode and the separation mode in the split mode, according to a user input or a pre-set value of the web browser. For example, the user may change the space mode to the connection mode by selecting a ‘connect windows’ button from the web browser or to the separation mode by selecting a ‘separate windows’ button.

Meanwhile, when the space mode is a connection mode, the space splitter 310 sets one of the at least two spaces as a main space, sets a margin on a periphery of the main space, and displays a web page in a region of the main space excluding the margin. In other words, the space splitter 310 sets the main space in the connection mode and displays the margin around the web page displayed in the main space. Also, according to an embodiment, when an input of selecting a link in the web page displayed in the main space is received, a web page corresponding to the link may be loaded in a space other than the main space. In other words, when the link in the web page displayed in the main space is selected in the connection mode, the web page of the link may be loaded and displayed in the other space. According to an embodiment, when the user selects a link in a web page displayed in a space in the connection mode, a web page of the selected link is loaded and displayed in another space, and thus web browsing may be conveniently performed.

Meanwhile, when the space mode is the split mode and a separation mode, and an input of selecting a link in the web page displayed in one of the at least two spaces is received, the space splitter 310 may load a web page corresponding to the link from the one space. In other words, according to an embodiment, when a link in a web page displayed in one space is selected in the separation mode, a web page corresponding to the link may be loaded and displayed in the one space, not in another space. In other words, in the separation mode, a web page corresponding to the link may be loaded and displayed in the same manner as an existing web browsing method, except that one tab includes at least two spaces in the separation mode,

Also, the space splitter 310 may determine an active page from among the web pages displayed respectively in the at least two spaces, and set an index of the tab or a URL emphasis mark based on information of the active page. Here, an active page denotes a web page that received a most recent input of a user, from among a plurality of web pages displayed in a content display region. A most recent input of a user may denote any type of input of the user intended to perform an action on a web page, such as an input of selecting a particular link in the web page, an input of clicking a particular region of the web page, and an input to an input window of the web page. Each of web pages displayed in respective spaces may include information displayed in an index of a tab or URL information while being loaded in a web browser. For example, while loading a web page of ‘aaa.com’, the web browser may obtain information displayed in the index or information indicated in the URL. Accordingly, when the web page of ‘aaa.com’ is loaded, ‘portal aaa’ may be displayed in the index and ‘aaa.com’ may be displayed in a URL display window of a tool bar region. According to an embodiment, when a tab includes a plurality of spaces, since a plurality of web pages are displayed in a web browser, a user may recognize which web page is currently activated through an index of the tab or an emphasis mark on the tool bar region. For example, when web pages of ‘aaa.com’ and ‘bbb.com’ are displayed respectively in spaces of one tab, and an active page is ‘aaa.com’, ‘portal aaa’ may be displayed in an index of the tab, and ‘aaa.com’ and ‘bbb.com’ are displayed in the tool bar region while a URL emphasis mark is added to ‘aaa.com’. The URL emphasis mark may be achieved by bold lettering a URL, varying colors, or adding a border around the URL. Also, according to an embodiment, when the space mode of the tab is the separation mode, an active mark may be added outside a space including an active page. Here, the active mark outside the space may be a shadow effect given to the outside of the space. Accordingly, the user may determine which one of the web pages is currently activated.

Also, when a plurality of web pages are displayed respectively in spaces, the space splitter 310 may process a scroll bar of the web page to be translucent and overlay the scroll bar on the web page. Also, when an input of manipulating the scroll bar is received from a user, for example, when a pointer is over the scroll bar, the scroll bar may be enlarged and/or transparency of the scroll bar may be reduced such that the scroll bar is easily recognized by the user.

Next, in operation S43, the adjustment determiner 320 determines at least one adjustment target web page from among the web pages respectively displayed in the at least two spaces, and determines whether to adjust the scale or size of the adjustment target web page or load another version of the adjustment target web page. Accordingly, the adjustment determiner 320 may determine the scale of the adjustment target web page or loading of the other version of the adjustment target web page.

The at least one adjustment target web page determined by the adjustment determiner 320 may be the web pages displayed in all of the spaces or a web page displayed in one space. According to an embodiment, when the tab is split into at least two spaces or when there is a user's request, the adjustment determiner 320 may determine the web pages displayed in all of the at least two spaces as the adjustment target web pages. Alternatively, when the sizes of the spaces are changed by movement of a dividing line between the spaces, the adjustment determiner 320 may determine the web pages displayed in the spaces whose sizes are changed as the adjustment target web pages. According to another embodiment, the adjustment determiner 320 may determine the web page displayed in one of the at least two spaces as the adjustment target web page. For example, the adjustment determiner 320 may determine a web page displayed in one space selected according to a user input as the adjustment target web page. Alternatively, the adjustment determiner 320 may determine a web page displayed in the main space or the left space as the adjustment target web page.

Also, when the tab is split into at least two spaces, the adjustment determiner 320 may automatically determine the adjustment target web page. When the space mode is changed from a general mode to the split mode, the adjustment determiner 320 may automatically determine the adjustment target web page. According to an embodiment, the adjustment determiner 320 may determine the web page displayed in the main space as the adjustment target web page. Alternatively, according to another embodiment, the adjustment determiner 320 may determine the adjustment target web page according to a user input. For example, when the user selects a web page and then inputs a scale adjusting instruction or selects a version changing button, the selected web page may be determined as the adjustment target web page.

Also, the adjustment determiner 320 may determine whether to adjust the scale of the adjustment target web page or load another version of the adjustment target web page. Whether to adjust the scale or load the other version may be determined based on a pre-set value of the web browser or user's request. For example, when the pre-set value of the web browser is for adjusting a scale of the web page during the space split, the adjustment determiner 320 may adjust the scale of the adjustment target web page. As another example, when the pre-set value of the web browser is for adjusting a version of the web page during the space split, the adjustment determiner 320 may load the other version of the adjustment target web page, According to an embodiment, since the adjustment determiner 320 determines whether to adjust the scale or load the other version of the adjustment target web page, information searching convenience may be increased for the user viewing the web page displayed in the space having the reduced size,

Although not illustrated in FIG. 4, the adjustment determiner 320 may determine to maintain the current scale of the adjustment target web page or not to load the other version of the adjustment target web page, in operation S43.

Then, when it is determined to adjust the scale in operation S43, the web page adjuster 330 adjusts the scale of the adjustment target web page in operation S44. For example, the web page adjuster 330 may adjust a scale of a web page such that a length or width of content of the web page displayed in a space is equal to or smaller than a length or width of the space. Alternatively, the web page adjuster 330 may adjust a scale of a web page such that a length or width of content of the web page displayed in a space is equal to a length or width of the space. Here, the web page adjuster 330 may adjust a scale within a pre-set scale minimum or maximum value range. Also, as described above, the adjustment target web page may be determined based on a user's request, and at this time, the web page adjuster 330 may adjust the scale of the adjustment target web page according to an adjustment scale value included in the user's request.

According to an embodiment, when the number of web pages displayed on the web browser increases, the sizes of areas for displaying the web pages are reduced. For example, when a first tab includes only one space and a second tab includes two spaces in one web browser, a web page may be displayed in the entire region of the first tab but first and second web pages are displayed respectively in the two spaces of the second tab. Accordingly, the sizes of areas for displaying the first and second web pages in the second tab may be half of the size of an area for displaying the web page in the first tab. According to an embodiment, a scale of a web page may be reduced such that content of the web page is suitably displayed on a web browser even when a web page display region is reduced when a tab is split into at least two spaces,

When it is determined to load the other version in operation S43, the adjustment determiner 320 determines whether the current version of the adjustment target web page is a first version or a second version in operation S45. Versions of a web page may be designed to enhance a view for the user according to a size of a display displaying the web page or a type of firmware loading the web page. For example, the first version, which is a version of a web page provided when a user terminal is a desktop computer, may be a PC version, and the second version, which is a version of a web page provided when a user terminal is a portable device, such as a smart phone, may be a mobile version, Here, the second version of the web page may have a smaller total data amount of the web page than the first version, or may be a version in which a width or length of the web page is adjusted according to a mobile display environment. For example, a URL of a first version of AAA.com may be ‘www.AAA.com’ and URL of a second version of AAA,com may be ‘m.AAA.com’.

When it is determined that the version of the adjustment target web page is the first version in operation S45, the web page adjuster 330 may load the second version of the adjustment target web page in operation S46. In other words, the web page adjuster 330 may load the other version of the adjustment target web page. As described above, the first version of the web page may have a larger total data amount than the second version, and the second version may be a mobile version compatible with a smaller display screen than the first version. Accordingly, when the second version of the adjustment target web page is loaded by the web page adjuster 330, the size of the space of the adjustment target web page may be reduced, but user inconvenience experienced when searching for information of the web page may be decreased. In other words, according to an embodiment, a version of a web page may be changed such that content of the web page is suitably displayed on a web browser even through a web page display region is reduced when a tab is split into at least two spaces.

Also, when it is determined that the version of the adjustment target web page is the second version in operation S45, the web page adjuster 330 may load the first version of the adjustment target web page in operation S47. For example, when the user selects the version changing button of the web browser, the first version may be loaded when the current version of the adjustment target web page is the second version. Alternatively, when the space mode is changed from the split mode to the general mode, the first version of the adjustment target web page may be loaded so as to provide detailed content to the user.

According to an embodiment, operations S45 through S47 may be performed when there is a version changing input from the user. Here, the version changing input may be an input of selecting the version changing button operating as a toggle key. Also, the adjustment target web page that is a target of the version changing input may be the web pages displayed in all of the spaces or the web page displayed in the space selected by the user. For example, when there is the version changing input of the user, the web page adjuster 330 may load the second version when the current version of the adjustment target web page is the first version, and load the first version when the current version is the second version.

According to another embodiment, when it is determined that the version of the adjustment target web page is determined to be the second version in operation S45, the web page adjuster 330 may maintain the second version of the adjustment target web page. When the sizes of the spaces are reduced as the tab is split into at least two spaces, it may be easier to search for information when the adjustment target web page maintains the second version.

According to another embodiment, when the adjustment target web page only has one of the first and second versions, the web page adjuster 330 may continuously maintain the current version of the adjustment target web page.

Then, the tool bar region splitter 340 may provide a tool bar region corresponding to each of the at least two spaces. A tool bar region provided by a web browser according to an embodiment may include an element indicating a state of a web page displayed in a space and an element for generating an instruction for controlling the web browser or web page. For example, the tool bar region may include a URL display window indicating a URL address of a current web page as the element indicating the state of the web page, and various tool buttons as the element for generating the instruction for controlling the web browser or web page. According to an embodiment, when the space mode is the split mode, the tool bar region may be provided to correspond to each of the at least two spaces. In particular, according to an embodiment, when the space mode is the split mode and the separation mode, the tool bar region may be provided to correspond to each of the at least two spaces.

For example, a tool bar region corresponding to each of at least two spaces may include an element indicating the state of a web page displayed in a corresponding space and an element for generating an instruction for controlling the web page. In other words, the tool bar region may include the element indicating the state of the web page or the element for controlling the web page such that the user may easily input a control instruction or obtain state information per individual space. Also, according to an embodiment, in addition to the tool bar region corresponding to each of the at least two spaces, a common tool bar region including an element for generating an instruction for controlling a web browser may be additionally provided. For example, the tool bar region corresponding to each space may include a URL display window, a reload button, and a version changing button, and the common tool bar region may include a capture button and a space mode button.

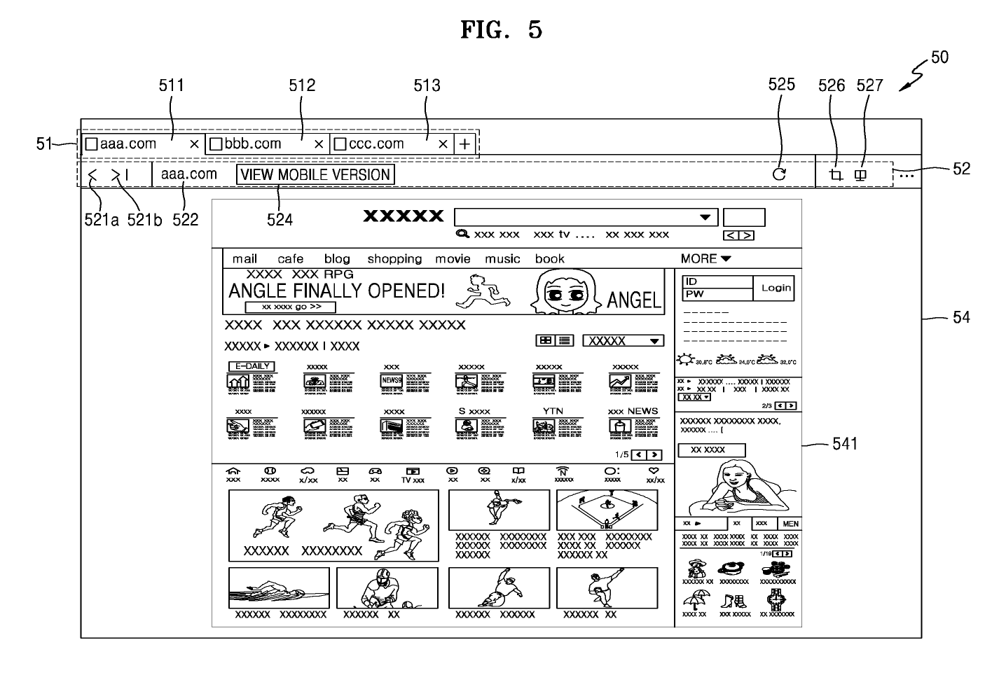

FIG. 5 illustrates an example of a web browser according to an embodiment.

In FIG. 5, the web browser 50 according to an embodiment is displayed on the display screen 215a in the user terminal 110 of FIG. 2. The web browser 50 may include a tab index display region 51, a tool bar region 52, and a content display region 54. The web browser 50 in FIG. 5 is only an example, and another component may be added to the web browser 50 or a component of the web browser 50 may be removed as long as the core concept of the present disclosure is maintained.

The tab index display region 51 may provide indexes for distinguishing between tabs loaded in the web browser 50. The web browser 50 according to an embodiment may provide a tab browsing function. Tab browsing denotes that one web browser 50 generates at least one tab and a web page may be browsed through each tab. Here, when a user selects an index of a tab desired to be displayed from the tab index display region 51, the tab is displayed in the content display region 54. In FIG. 5, an index 511 of a first tab is selected according to an embodiment.

In the embodiment of FIG. 5, the tab index display region 51 includes indexes 511 through 513 of first through third tabs, wherein the indexes 511 through 513 may display titles of web pages respectively loaded in the first through third tabs, or titles of active pages from among web pages loaded in the first through third tabs, For example, in the embodiment of FIG. 5, the index 511 is activated, and the title of a web page 541 of the index 511 is displayed in the index 511.

The tool bar region 52 may include an element indicating a state of a web page displayed in a space in the web browser 50 and an element for generating an instruction for controlling the web page or web browser 50. For example, the tool bar region 52 may include a URL display window indicating a URL address of a current web page as the element indicating the state of the web page, and various tool buttons as the element for generating the instruction for controlling the web browser 50 or web page. In addition to the elements shown in FIG. 5, the tool bar region 52 may include a mark for indicating the state of the web page and buttons for executing various tools.

For example, as shown in FIG. 5, the tool bar region 52 may include a backward button 521a and a forward button 521b. Also, the tool bar region 52 may display a URL of a currently activated tab, The URL of the currently activated tab is a URL of a web page being loaded and displayed in the content display region 54. In the embodiment of FIG. 5, the tool bar region 52 displays ‘aaa.com’ 522 that is a URL of the first tab. A region of the tool bar region 52 where a URL is displayed may operate as a display window displaying the state of the web page, and at the same time, operate as a tool generating an instruction for controlling the web page because, when the user directly inputs a URL, a web page of the URL is loaded.

Also, the tool bar region 52 may additionally include a version changing button 524. The user may select the version changing button 524 to change a version of a currently displayed web page. For example, when the version changing button 524 is selected while a first version of a web page is displayed in the content display region 54, a second version of the web page may be loaded, and when the version changing button 524 is selected while the second version is displayed, the first version of the web page may be loaded. When the first version is a PC version and the second version is a mobile version according to an embodiment, the version changing button 524 may display ‘view mobile version’ to indicate that the web page may be changed from the PC version to the mobile version, as shown in FIG. 5.

Also, the tool bar region 52 may include buttons of tools for generating instructions for controlling a web page or web browser 50, such as a reload icon 525, a capture icon 526, and a split mode button 527. In particular, according to an embodiment, the user may select the split mode button 527 to split an activated tab into at least two spaces. In other words, when the split mode button 527 is selected, a space mode of a tab may be changed from a general mode to a split mode. For example, when a tab includes only one space as shown in FIG. 5, the user may select the split mode button 527 such that the tab is split to have at least two spaces. The split mode button 527 may act as a toggle key, and when the split mode button 527 is selected in the split mode, the space mode may be changed to the general mode.

The content display region 54 may display content of an activated tab. Content of an activated tab may be a web page loaded and displayed via the activated tab. In the embodiment of FIG. 5, a space mode of the first tab that is activated is a general mode, and the web page 541 is displayed in one space.

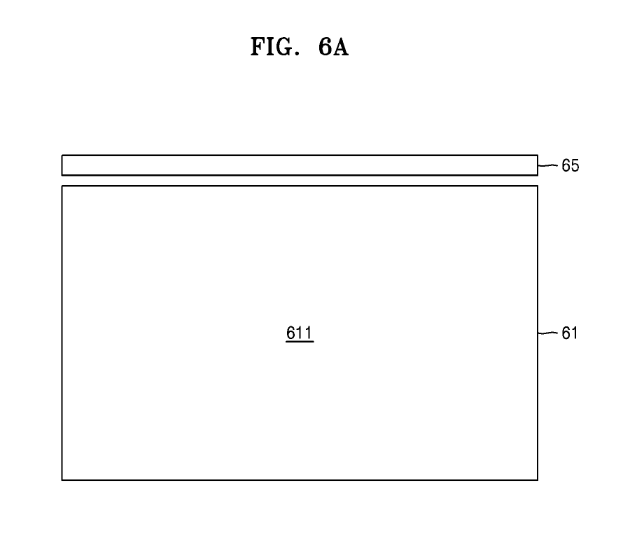

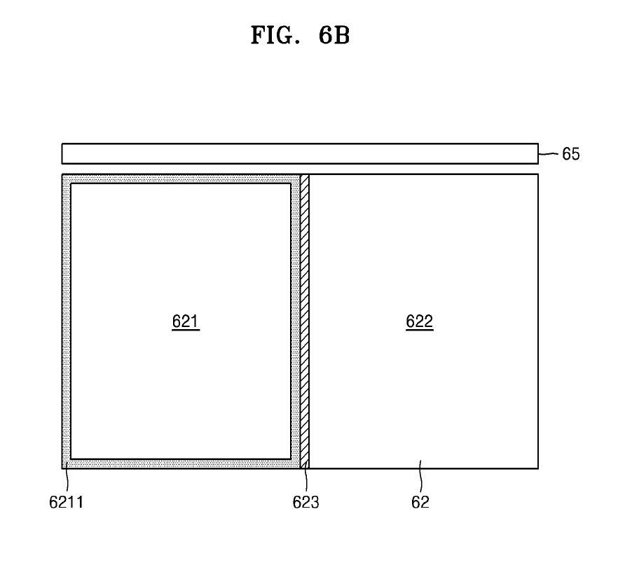

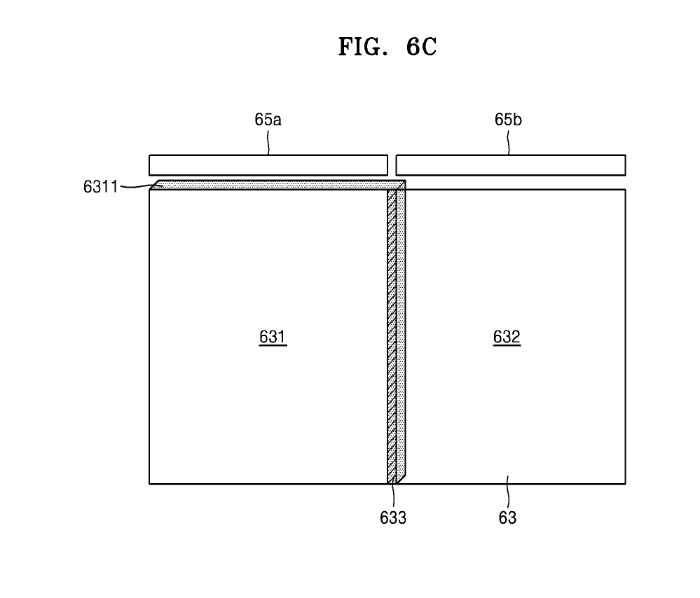

FIGS. 6A through 6C illustrate examples of tabs 61 through 63, and a tool bar region 65 and first and second tool bar regions 65a, and 65b according to space modes, according to an embodiment. The tabs 61 through 63 of FIGS. 6A through 6C may be displayed in the content display region 54 of FIG. 5.

FIG. 6A illustrates an example of the tab 61 when the space mode is a general mode. The tab 61 includes only one space 611 in the web browser, only one web page is displayed in the space 611, and one tool bar region 65 may be provided.

FIG. 6B illustrates an example of the tab 62 when the space mode is a split mode and a connection mode. The tab 62 is split into two spaces in the web browser, i.e., a first space 621 and a second space 622, and a dividing line 623 may divide the first and second spaces 621 and 622. A web page may be displayed in each of the first and second spaces 621 and 622. According to an embodiment, one of a plurality of spaces may be set as a main space, and a margin may be set in a periphery of the main space. When the margin is set, a user may clearly recognize which space is the main space. In FIG. 6B, one tool bar region 65 may be provided like FIG. 6A, wherein elements of the tool bar region 65 may operate with respect to an active page.

Also, a web page may be displayed in a region of the main space excluding the margin. According to an embodiment, the main space may be set to be a left space. In the example of FIG. 6B, the first space 621 is set as a main space, and a margin 6211 is set in a periphery of the first space 621. As described above, when a link in a web page displayed in the first space 621 is selected, a web page corresponding to the link may be displayed in the second space 622.

FIG. 6C illustrates an example of the tab 63 when the space mode is a split mode and a separation mode. The tab 63 is split into at least two spaces in the web browser, i.e., a first space 631 and a second space 632, and a dividing line 633 may divide the first and second spaces 631 and 632. A web page may be displayed in each of the first and second spaces 631 and 632. According to an embodiment, unlike the connection mode, a main space is not set in the separation mode, but a plurality of spaces may individually operate. In other words, when a link in a web page displayed in the first space 631 is selected in the separation mode, a web page corresponding to the link may be displayed in the first space 631. In the separation mode, an active mark may be set with respect to a space displaying an active web page. In the embodiment of FIG. 6C, when the first space 631 displays an active web page, a shadow effect is set as an active mark 6311 at edges of the first space 631. The active mark 6311 may be set in various ways other than the example shown in FIG. 6C.

Also, according to an embodiment, in FIG. 6C, the first and second tool bar regions 65a and 65b are provided to respectively correspond to the first and second spaces 631 and 632 when the space mode is a split mode and a separation mode. In FIG. 6C, the first and second spaces 631 and 632 may exist, and the first and second tool bar regions 65a and 65b may be provided respectively for the first and second spaces 631 and 632. Each of the first and second tool bar regions 65a and 65b may include an element indicating the state of a web page displayed in a corresponding space or an element for generating an instruction for controlling the web page. A web browser according to an embodiment generates and provides two tool bar regions when the space mode is a separation mode and a split mode such that a user recognizes that spaces will individually operate and at the same time, easily determine and control the state of a web page displayed in each of the spaces.

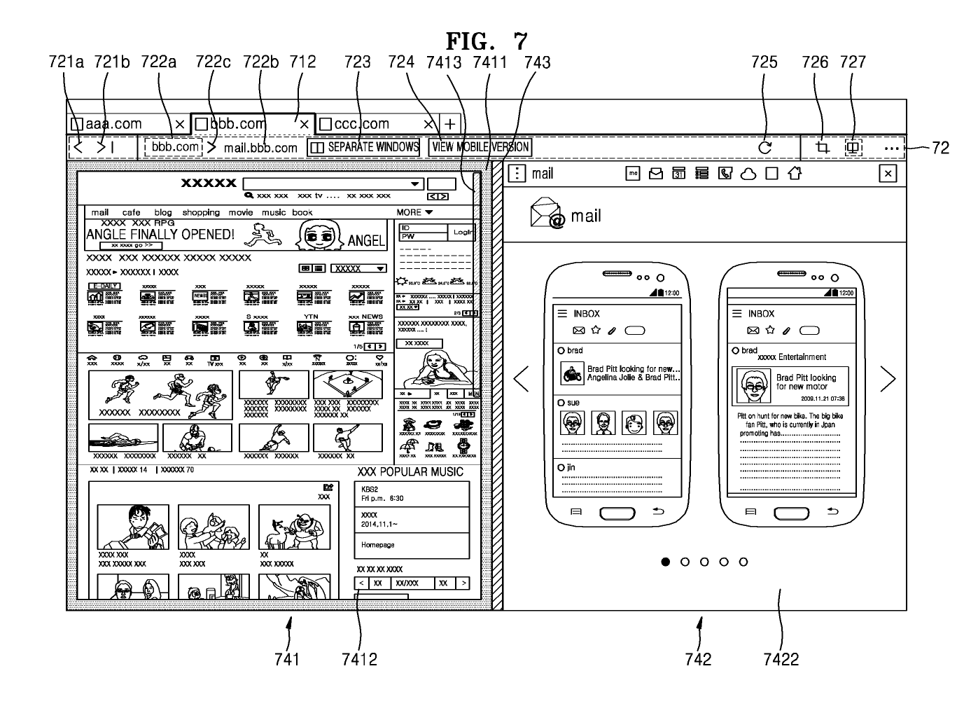

FIG. 7 illustrates a web browser according to an embodiment.

FIG. 7 illustrates a web browser where the space mode of a selected tab is a split mode and a connection mode, and scales of web pages displayed in spaces in the web browser are adjusted. In the embodiment of FIG. 7, an index 712 of a second tab is selected from a tab index display region, wherein a space mode of the second tab is a split mode and a connection mode. A tool bar region 72 may display a URL 722a of a web page displayed in a first space 741 and a URL 722b of a web page displayed in a second space 742 together, and a delimiter 722c dividing the URLs 722a and 722c. Here, a shape of the delimiter 722c may vary based on whether the space mode is the connection mode or the separation mode. In addition, the tool bar region 72 may further display a backward button 721a, a forward button 721b, a reload button 725, and a capture button 726 as described above with reference to FIG. 5.

Also, the tool bar region 72 may display a separation button 723. The separation button 723 may be a toggle key which, when selected by a user, changes the space mode from the connection mode to the separation mode or from the separation mode to the connection mode. For example, as shown in FIG. 7, when the space mode is the connection mode, the user may select the separation button 723 to change the space mode to the separation mode. In order to indicate that the space mode may be changed to the separation mode, a guide ‘separate windows’ may be included in the separation button 723. Also, since the second tab selected in FIG. 7 is in the split mode, a dashed borderline mark indicating that a split mode icon 727 is activated may be added in the tool bar region 72.

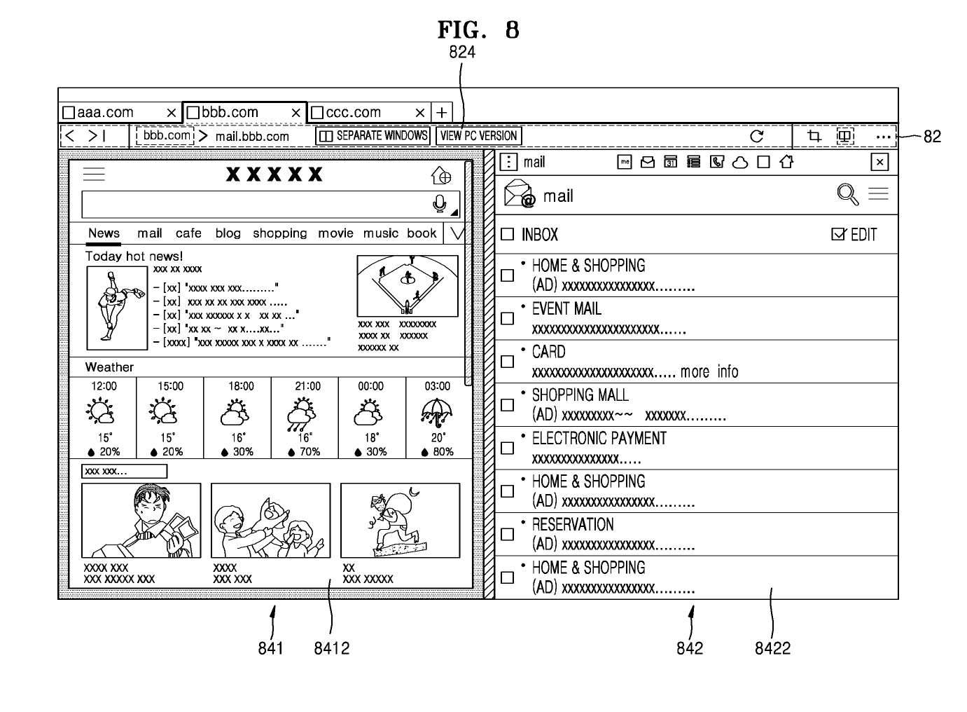

Also, the tool bar region 72 of FIG. 7 may display a version changing button 724. The version changing button 724 corresponds to the version changing button 524 of FIG. 5, and when the user selects the version changing button 724, versions of first and second web pages 7412 and 7422 displayed in the first and second spaces 741 and 742 may be changed. In the embodiment of FIG. 7, first versions (PC versions) of the first and second web pages 7412 and 7422 are displayed, and thus the version changing button 724 may display a guide ‘view mobile version’ to indicate that the versions may be changed to second versions (mobile versions). When the user selects the version changing button 724, the second versions of the first and second web pages 7412 and 7422 may be loaded. This will be described in detail below with reference to FIG. 8.

Referring to FIG. 7, the scales of the first and second web pages 7412 and 7422 displayed in the first and second spaces 741 and 742 are adjusted. The first web page 7412 is a web page obtained by adjusting the scale of the web page 541 of FIG. 5 when the space mode of the web browser is changed to the split mode. The scales of the first and second web pages 7412 and 7422 may be adjusted such that the widths of the first and second spaces 741 and 742 and the widths of the first and second web pages 7412 and 7422 match each other. Here, the scales of the first and second web pages 7412 and 7422 may be automatically adjusted when the space mode of the web browser is changed to the split mode or may be adjusted according to a user input. According to an embodiment, the scales of the first and second web pages 7412 and 7422 may be adjusted such that the user easily recognizes content displayed by the first and second web pages 7412 and 7422 even in the split mode.

Although not illustrated in FIG. 7, according to another embodiment, the scale of one of the first and second web pages 7412 and 7422 may be selectively adjusted. For example, only the scale of the first web page 7412 displayed in the first space 741 that is a main space may be adjusted. Alternatively, the user may input an instruction for selecting and adjusting the scale of one of the first and second web pages 7412 and 7422.

The first and second spaces 741 and 742 of the second tab are displayed in a content display region of FIG. 7, and a first web page 7412 is displayed in the first space 741 and a second web page 7422 is displayed in the second space 742. The first and second spaces 741 and 742 may be divided by a dividing line 743, and the user may adjust the sizes of the first and second spaces 741 and 742 by adjusting the location of the dividing line 743. As shown in FIG. 6B, when the space mode is the connection mode, a margin 7411 is displayed in a periphery of the first space 741, i.e., a main space, and the first web page 7412 may be displayed in a region of the first space 741 excluding the margin 7411.

Also, a scroll bar 7413 processed to be translucent may be included in the first web page 7412 and/or the second web page 7422 to overlay the first web page 7412 and/or the second web page 7422. In FIG. 7, the scroll bar 7413 is illustrated only on the right of the first web page 7412, but the scroll bar 7413 may exist on the bottom of the first web page 7412 if required. When a content display region of a web browser is split into at least two spaces to display web pages, areas for displaying the web pages are decreased. Accordingly, a web browser according to an embodiment does not assign a separate area for a scroll bar, but overlays a translucent scroll bar on a web page.

As shown in FIG. 7, when the space mode of the second tab that is selected is the split mode and the connection mode, and an input of selecting a link in the first web page 7412 displayed in the first space 741 that is the main space is received, a web page corresponding to the link may be loaded in the second space 742. In the embodiment of FIG. 7, when the user selects a ‘mail’ link in the first web page 7412, the second web page 7422 shown in FIG. 7 is loaded, The user may determine that a left space, i.e., the first space 741, is the main space through indication of the margin 7411, and may select a link in the first web page 7412 displayed in the main space to load and display a web page corresponding to the link in a right space, i.e., the second space 742.

FIG. 8 illustrates a web browser according to another embodiment.

FIG. 8 is a modified example of FIG. 7, and details overlapping those of FIG. 7 may be omitted.

FIG. 8 illustrates an example in which versions of first and second web pages 8412 and 8422 displayed in first and second spaces 841 and 842 in the web browser are changed from the embodiment of FIG. 7. For example, a mobile version of the first web page 8412 is displayed in the first space 841 and a mobile version of the second web page 8422 is displayed in the second space 842 because the versions of the first and second web pages 7412 and 7422 of FIG. 7 were the first version, i.e., the PC version, and the second version of the first and second web pages 8412 and 8422 are loaded after the user selected the version changing button 724. Referring to FIG. 8, a version changing button 824 may display a guide ‘view PC version’ to indicate that a web page in a PC version may be loaded when the version changing button 824 is selected.

Alternatively, the versions of the first and second web pages 8412 and 8422 may be automatically changed as shown in FIG. 8 even when the user does not select the version changing button 724 or 824. For example, when a space mode is changed from a general mode to a split mode, the versions of the first and second web pages 8412 and 8422 may be changed to the second version. Since a size of an individual space for displaying a web page is reduced when a space mode is changed from a general mode to a split mode, a second version is displayed on a web browser such that content is easily recognized even in a small region.

Although not illustrated in FIG. 8, according to another embodiment, the version of one of the first and second web pages 8412 and 8422 may be selectively changed. For example, the second version of only the first web page 8412 displayed in the first space 841, i.e., a main space, may be loaded. Alternatively, the user may input an instruction for selecting and loading another version of one of the first and second web pages 8412 and 8422.

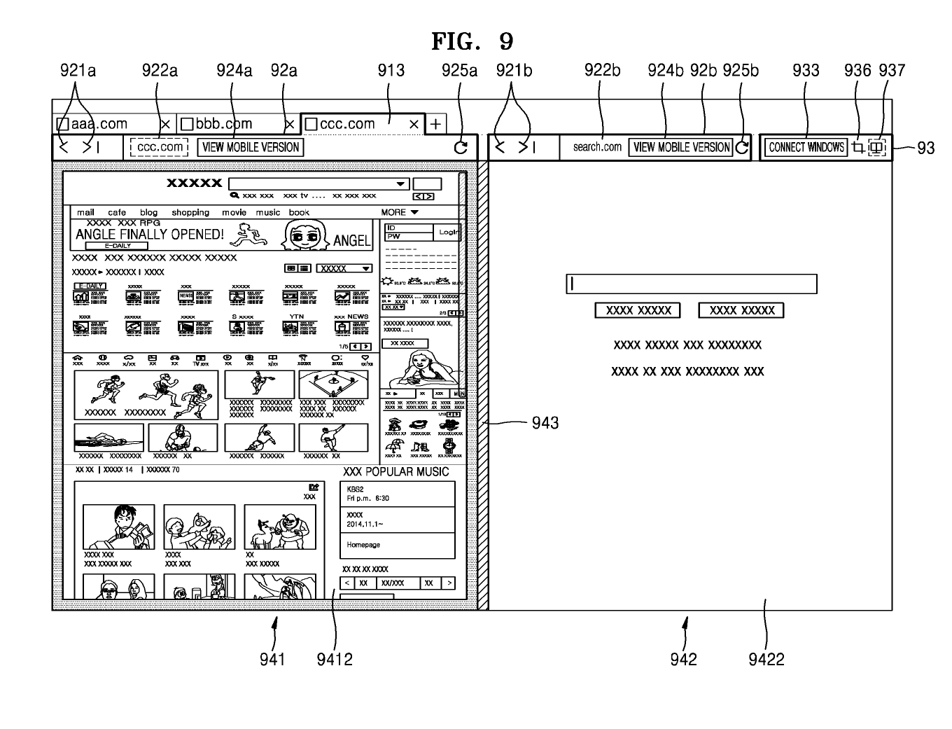

FIG. 9 illustrates a web browser according to another embodiment.

FIG. 9 is a modified example of FIG. 7, and details overlapping those of FIG. 7 may be omitted. FIG. 9 illustrates a web browser in which a space mode of a selected tab is a split mode and also a separation mode. In the embodiment of FIG. 9, an index 913 of a third tab is selected from a tab index display region, and a space mode of the third tab is a split mode and a separation mode.

A content display region of FIG. 9 displays a first space 941 and a second space 942 of the third tab, wherein a first web page 9412 is displayed in the first space 941 and a second space 9422 is displayed in the second space 942 in the web browser. The first and second spaces 941 and 942 may be divided by a dividing line 943 and the user may adjust the location of the dividing line 943 to adjust the sizes of the first and second spaces 941 and 942. Although not illustrated in FIG. 9, as described with reference to FIG. 6C, when the space mode is the separation mode, an active mark may be set around the first space 941 including an active page.

When a space mode of a selected tab is a split mode and a separation mode as shown in FIG. 9, a plurality of spaces may individually operate unlike in a connection mode. In other words, even when a link in the first web page 8412 displayed in the first space 941 is selected, a web page corresponding to the link may be displayed in the first space 941 as the first web page 9412. Similarly, even when a link in the second web page 9422 displayed in the second space 942 is selected, a web page corresponding to the link may be displayed in the second space 942 as the second web page 9422.

In the embodiment of FIG. 9, the web browser according to an embodiment may include tool bar regions corresponding to each space. For example, the tool bar regions may include a first tool bar region 92a, a second tool bar region 92b, and a third tool bar region 93. The first tool bar region 92a corresponds to the first space 941, the second tool bar region 92b corresponds to the second space 942, and the third tool bar region 93 includes tool buttons for generating instructions commonly applied to the first and second spaces 941 and 942.

First, the first tool bar region 92a corresponds to the first space 941, and may include backward/forward buttons 921a, a URL 922a, a version changing button 924a, and a reload button 925a. The URL 922a displays a URL of the first web page 9412 displayed in the first space 941, and the backward/forward buttons 921a, the version changing button 924a, and the reload button 925a may each generate an instruction for controlling the first web page 9412. A URL emphasis mark may be added to the URL 922a of FIG. 9 to indicate that the first web page 9412 is an active page.

Also, the second tool bar region 92b corresponds to the second space 942, and may include backward/forward buttons 921b, a URL 922b, a version changing button 924b, and a reload button 925b. The URL 922b displays a URL of the second web page 9422 displayed in the second space 942, and the backward/forward buttons 921b, the version changing button 924b, and the reload button 925b may each generate an instruction for controlling the second web page 9422.

In other words, the first and second tool bar regions 92a and 92b respectively correspond to the first and second spaces 941 and 942, and may include an element, such as a display window indicating a state of a web page displayed in a space or a button for generating an instruction for controlling a web page.

In addition, the third tool bar region 93 may include an element for generating an instruction for controlling a web browser, which is commonly applied to the first and second spaces 941 and 942. In the embodiment of FIG. 9, the third tool bar region 93 may include a connection button 933, a capture button 936, and a space mode button 937. The connection button 933, the capture button 936, and the space mode button 937 may all be used to generate instructions for capturing a screen of the web browser and changing the space mode of the web browser, regardless of a space. For example, when the space mode of the tab is the separation mode as shown in FIG. 9, the connection button 933 may be selected to change the space mode to the connection mode. In order to indicate that the space mode may be changed to the connection mode, the connection button 933 may include a guide ‘connect windows’. Also, since the space mode is the split mode, a mark indicating that the space mode button 937 is activated may be added to the third tool bar region 93.

When a tool bar region is provided per space as shown in FIG. 9, a state of a web page displayed in a space may be easily indicated or an instruction for controlling the web page may be easily input. According to another embodiment, when a tool bar region is not provided per space as shown in FIG. 8, elements for generating instructions for controlling a web page may be used to control a web page that is currently active.

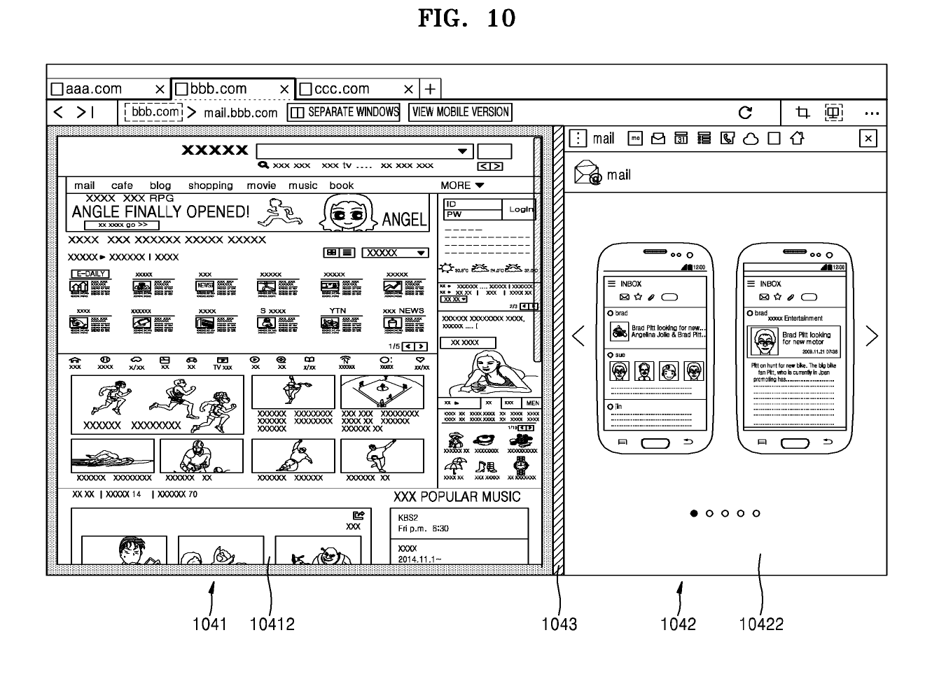

FIG. 10 illustrates a web browser according to another embodiment.

FIG. 10 is a modified example of FIG. 7, and details and reference numerals overlapping those of FIG. 7 may be omitted or briefly displayed. Differences between the web browsers of FIGS. 7 and 10 are that a dividing line 1043 is more to the right than the dividing line 743 of FIG. 7, and scales of the first and second web pages 10412 and 10422 are automatically adjusted.

In other words, in comparison with FIG. 7, in the embodiment of FIG. 10, the size of a first space 1041 in the web browser is larger and a size of the second space 1042 is smaller because the dividing line 1043 is more to the right than that of the dividing line 743 in FIG. 7. The user may move the dividing line 1043 from side to side to adjust the sizes of the first and second spaces 1041 and 1042. Here, when the sizes of the first and second spaces 1041 and 1042 are adjusted by moving the dividing line 1043, scales of the first and second web pages 10412 and 10422 may be adjusted according to the sizes of the first and second spaces 1041 and 1042, For example, the scales of the first and second web pages 10412 and 10422 may be adjusted such that lengths or widths of contents of the first and second web pages 10412 and 10422 displayed in the first and second spaces 1041 and 1042 are equal to or smaller than lengths or widths of the first and second spaces 1041 and 1042, Accordingly, convenience for a user searching for information may be increased even when the size of a space is adjusted.

According to an embodiment, convenience for a user searching for information may be increased by adjusting a scale of at least one web page in a web browsing interface for displaying a web page in each of spaces.

Also, the user may easily control a plurality of web pages by providing a tool bar region corresponding to each of the spaces.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be modified in various ways. Such modifications are not to be regarded as a departure from the disclosure, and all such modifications are intended to be included within the scope of the disclosure.

What is claimed is:

1. A method of providing a web browsing interface on a display screen of a user terminal, the method comprising:
splitting a tab displayed on a web browser being executed on the user terminal into at least two spaces based on a space mode of the tab displayed on the web browser;
displaying web pages respectively on the at least two spaces;
performing an adjustment determining operation by determining at least one adjustment target web page from among the web pages respectively displayed on the at least two spaces and determining whether to adjust a scale of the at least one adjustment target web page or load another version of the at least one adjustment target web page;
performing a web page adjusting operation by adjusting the scale of the at least one adjustment target web page or loading the other version of the at least one adjustment target web page based on a result of performing the adjustment determining operation.

2. The method of claim 1, further comprising providing tool bar regions respectively corresponding to the at least two spaces based on the space mode.

3. The method of claim 2, wherein each of the tool bar regions respectively corresponding to the at least two spaces comprises an element indicating a state of a web page displayed in a corresponding space or an element generating an instruction of controlling the web page.

4. The method of claim 2, wherein, in the providing of the tool bar regions, the tool bar regions respectively corresponding to the at least two spaces are provided when the space mode is a separation mode,
wherein the separation mode is a mode of, when an input of selecting a link in a web page displayed in a particular space from among the at least two spaces is received, loading a web page corresponding to the link in the particular space.

5. The method of claim 1, wherein, in the performing of the adjustment determining operation, the determining of whether to load the other version comprises determining whether a version of the at least one adjustment target web page is a first version or a second version, and when it is determined that the version is the first version, loading the second version of the at least one adjustment target web page.

6. The method of claim 5, wherein the first version of the at least one adjustment target web page has a larger total data amount of a web page than the second version of the at least one adjustment target web page.

7. The method of claim 1, wherein one of the at least one adjustment target web page is displayed in a main space of the web browser, and
when an input of selecting a link in a web page displayed in the main space is received, the web browser loads a web page corresponding to the link in another space instead of the main space.

8. The method of claim 1, wherein one of the at least one adjustment target web page is displayed in a left space of the web browser.

9. The method of claim 1, wherein, in the performing of the adjustment determining operation, all of the web pages displayed respectively in the at least two spaces are determined as adjustment target web pages, or a web page selected based on a user input is determined as an adjustment target web page.

10. The method of claim 1, wherein, in the performing of the web page adjusting operation, the scale of the at least one adjustment target web page is adjusted such that lengths or widths of contents of the web pages respectively displayed in the at least two spaces are equal to or smaller than lengths or widths of the at least two spaces.

11. An apparatus for providing a web browsing interface on a display screen of a user terminal, the apparatus comprising:
a space splitter configured to split a tab displayed on a web browser being executed on the user terminal into at least two spaces based on a space mode of the tab displayed on a web browser, and display web pages respectively on the at least two spaces;
an adjustment determiner configured to determine at least one adjustment target web page from among the web pages respectively displayed on the at least two spaces and determine whether to adjust a scale of the at least one adjustment target web page or load another version of the at least one adjustment target web page; and
a web page adjuster configured to adjust the scale of the at least one adjustment target web page or load the other version of the at least one adjustment target web page based on a result of the determining by the adjustment determiner.

12. The apparatus of claim 1, further comprising a tool bar region splitter configured to provide tool bar regions respectively corresponding to the at least two spaces based on the space mode.

13. The apparatus of claim 11, wherein the adjustment determiner determines whether to load the other version by determining whether a version of the at least one adjustment target web page is a first version or a second version, and when it is determined that the version is the first version, loading the second version of the at least one adjustment target web page.

14. The apparatus of claim 11, wherein the adjustment determiner determines all of the web pages displayed respectively in the at least two spaces as adjustment target web pages, or a web page selected based on a user input as an adjustment target web page.
